(19) United States
(12) Patent Application Publication
(10) Pub. No.: US 2007/0214219 A1
(43) Pub. Date: Sep. 13, 2007

(54) Method of inquiring e-mail sending status in real time

(75) Inventor: Peng-Kwang Chen, Taipei City (TW)

Correspondence Address: TROXELL LAW OFFICE PLLC, SUITE 1404, 5205 LEESBURG PIKE, FALLS CHURCH, VA, 22041, US

(73) Assignee: Ultra Quantum E-ware Research Co., Ltd.

(21) Appl. No.: 11/370,030

(22) Filed: Mar. 8, 2006

(51) Int. Cl. G06F 15/16; G06F 15/177

(52) U.S. Cl. 709/206; 715/736

(57) ABSTRACT

A method of inquiring status of a sent e-mail includes displaying a screen of e-mail list having records each including size, subject, sending time, success times, failure times, and times to be sent; clicking the e-mail in the list to enter a screen about details of sent e-mails including a success sending portion and a failure sending portion including status description for indicating the cause of failure; linking the status description to enter a description screen including a flowchart for illustrating steps of the e-mail sending wherein the step is highlighted if an error is occurred therein and a corresponding description is shown; and showing an icon in an area on a computer screen for indicating whether the sent e-mail is a success or not. The sender is able to immediately send the failed e-mail again after correcting the error as shown.

### BACKGROUND OF THE INVENTION

1. Field of Invention

The present invention relates to e-mail sending and more particularly to a method of inquiring status of a sent e-mail in real time such that a sender is able to determine whether it is sent successfully or not and may take an appropriate action (i.e., send again) immediately if it is a failure.

2. Related Art

E-mail is much convenient than ordinary mail or telephone calls because it arrives immediately but does not require the recipient to be present, nor does it interrupt anything else the recipient is doing. A process of sending an e-mail is illustrated in FIG. 1. In step S1, a sender may edit an e-mail by means of Outlook Express or Web Mail. In step S2, the sender may send the e-mail to a sender server. In step S3, the server may give a serial number to the e-mail and store same in a memory of the server. In step S4, the server may analyze an address of the e-mail to be sent in order to obtain an IP (Internet Protocol) address of the recipient. An error message is generated in step S41 if an error is occurred in analyzing the address and the process then loops back to step S3. In step S5, the sender server attempts to establish a connection with a recipient server based on the obtained IP address of the recipient. An error message is generated in step S51 if an error is occurred in the connection establishment and the process then loops back to step S3. In step S6; the sender server may perform a SMTP (Simple Mail Transfer Protocol) procedure to attempt to communicate with the recipient server. An error message is generated in step S61 if an error is occurred in the communication and the process then loops then back to step S3. In step S7, the sender begins to send the e-mail to the recipient server. An error message is generated in step S71 if an error is occurred in the sending and the process then loops back to step S3. In step S8, a reply representing success (i.e., the recipient has received the e-mail) is sent from the recipient to the sender. An error message is generated in step S81 if an error is occurred in the reply sending (i.e., the sender does not receive the reply) and the process then loops back to step S3. In step S9, the sender server disconnects the communication with the recipient server and the process ends normally.

However, the prior art suffered from several disadvantages. For example, the process is a background one. That is, the sender is not aware which step is being done in the e-mail sending process. In fact, only the servers are aware of that. Further, a higher percentage of e-mail failure occurs due to sender error. Also, network staff does not inform the sender if such failure occurs. Instead, the erroneous e-mail is stored in the sender server temporarily and is sent again and again for a predetermined times (i.e., performing the steps S3 to S5 repeatedly). Finally, a failure message regarding the failed e-mail is sent to the sender. At this time (e.g., several hours or days thereafter), the sender is aware that the previously sent e-mail does not reach the recipient successfully. This is not tolerable since time is money and sometimes an e-mail is very important and has an immediate deadline. Hence, a need has arisen for an improved method of inquiring e-mail status (i.e., success or failure) after sending in real time.

### SUMMARY OF THE INVENTION

It is therefore an object of the present invention to in a sub-system of e-mail sending system provide a method of inquiring status of a sent e-mail in real time comprising displaying a screen of e-mail list having the sent e-mail added therein sequentially wherein the list comprises a plurality of records each representing one of the sent e-mails including serial number, size, subject, sending time, success times, failure times, and times to be sent; a sender is capable of clicking the e-mail in the list to enter a screen about details of sent e-mails; and the screen about details of sent e-mails is shown as a Windows screen or a Web page and includes a success sending portion having a plurality of records each including fields of recipient, date and time of first sending, sending times, time consumed, date and time of the beginning of last sending, date and time of the ending of last sending, and processing time, and a failure sending portion having a plurality of records reach including fields of recipient, date and time of first sending, sending times, time consumed, date and time of the beginning of last sending, date and time of next sending, date and time of the ending of last sending, processing time, and status description for indicating the cause of failure; linking the status description to enter a description screen including a flowchart for illustrating steps of the e-mail sending wherein the step is highlighted if an error is occurred therein and a corresponding description is shown; and showing an icon in an area on a computer screen for indicating whether the sent e-mail is a success or not. By utilizing the method, the sender is able to determine whether an e-mail is sent successfully or not and may take an appropriate action (i.e., send again) immediately if it is a failure.

In one aspect of the present invention the icon is linked to the screen about details of sent e-mails such that clicking the icon will enter the screen about details of sent e-mails.

The above and other objects, features and advantages of the present invention will become apparent from the following detailed description taken with the accompanying drawings.

### BRIEF DESCRIPTION OF THE DRAWINGS

FIG. 1 is a flowchart depicting a process of sending e-mail according to the prior art;

FIG. 2 shows a screen of e-mail list according to the invention;

FIG. 3 shows a screen about details of sent e-mails according to the invention;

FIG. 4 is a flowchart depicting a process of sending e-mail according to a preferred embodiment of the invention; and

FIG. 5 is an enlarged view of a portion of Windows screen showing an icon of the invention appeared thereon.

### DETAILED DESCRIPTION OF THE INVENTION

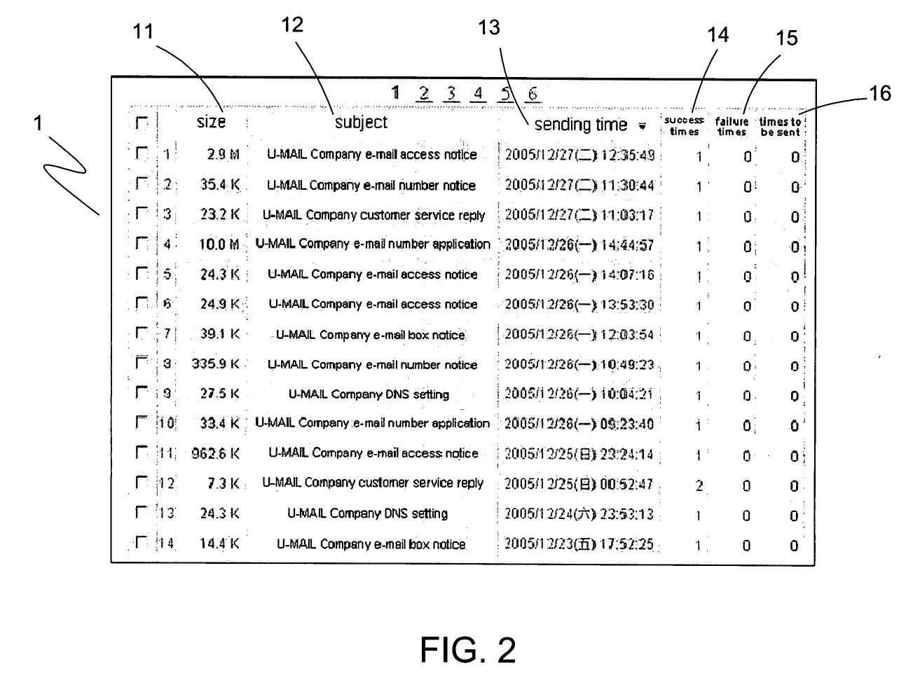

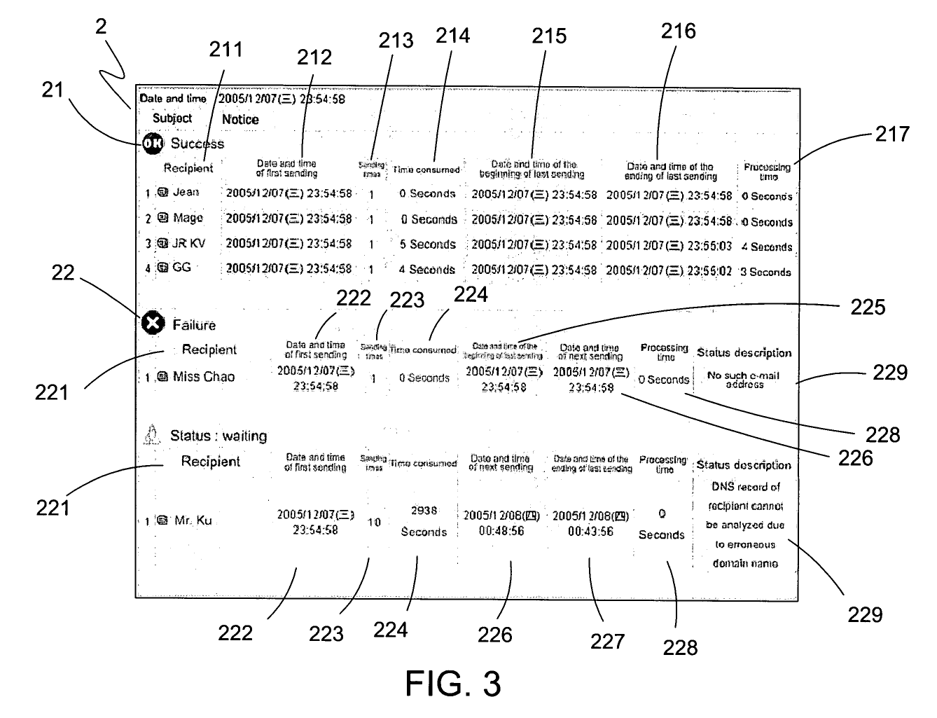

The invention is implemented in a sub-system of Web Mail. Referring to FIG. 2, a screen of e-mail list 1 is shown. An e-mail is added to the list 1 after being successfully sent from a sender to a sender server. Thus, the sender may inquiry all sent e-mails thereafter. The list 1 comprises a plurality of records each representing a sent e-mail including serial number, size 11, subject 12, sending time 13, success times 14, failure times 15, and times to be sent 16. A value other than zero in the field of failure times 15 means that the e-mail is sent unsuccessfully. Thus, the sender may use a mouse to click the failed e-mail in the list 1 to enter a screen 2 about details of sent e-mails as shown in FIG. 3.

In FIG. 3, the screen 2 is similar to a Windows screen or a Web page. As shown, a subject “Please review next year's budget” of an e-mail is clicked. The e-mail has been sent to a plurality of recipients in which two times of sending are failed. Thus, a success sending portion 21 and a failure sending portion 22 are formed on the screen 2. In the success sending portion 21, each row (i.e., record) comprises fields of recipient 211, date and time of first sending 212, sending times 213, time consumed 214, date and time of the beginning of last sending 215, date and time of the ending of last sending 216, and processing time 217.

In the failure sending portion 22, each row (i.e., record) comprises fields of recipient 221, date and time of first sending 222, sending times 223, time consumed 224, date and time of the beginning of last sending 225, date and time of next sending 226, date and time of the ending of last sending 227, processing time 228, and status description 229.

In the failure sending portion 22, two times of failed sending are shown. Also, one status description 229 indicates “no such e-mail address” and the other status description 229 indicates “DNS record of recipient cannot be analyzed successfully (i.e., erroneous domain name)”. The sender thus knows the cause of failure and may correct same accordingly. By utilizing this, an e-mail can be successfully sent to a recipient even if it was sent unsuccessfully in a previous time.

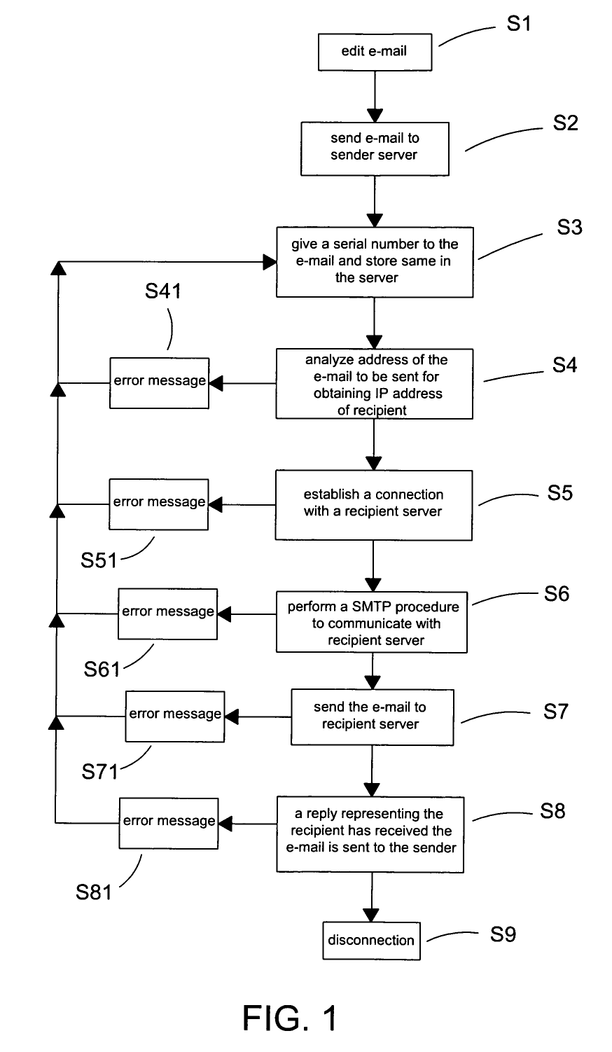

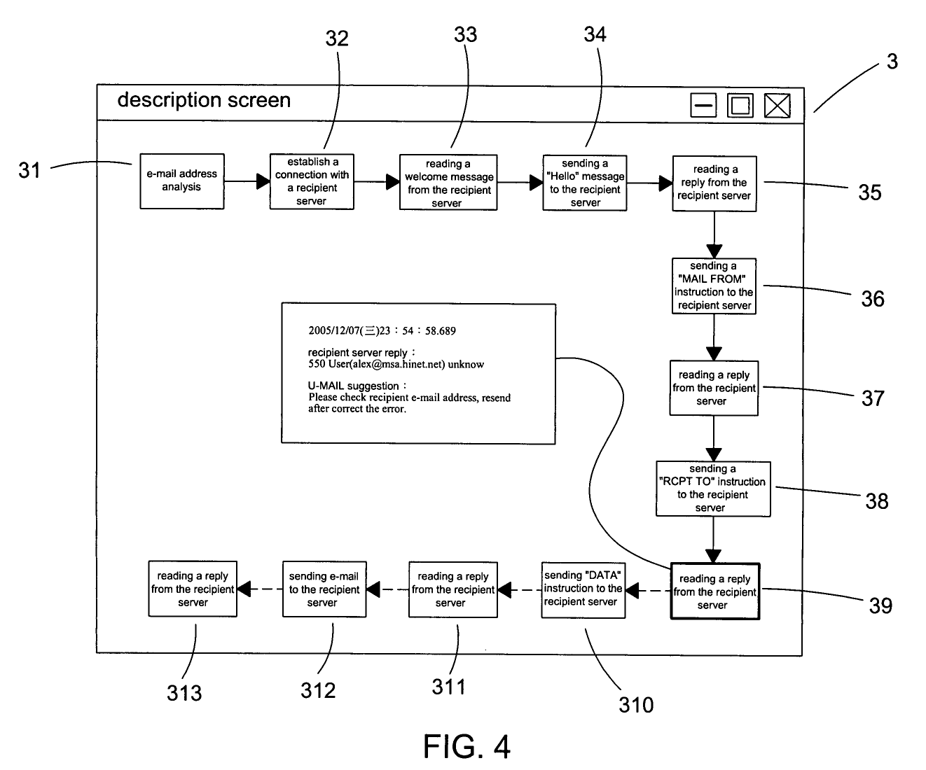

The status description 229 is linked to a description screen 3 as shown in FIG. 4. The sender may click the status description 229 to enter the description screen 3. The description screen 3 is implemented as a flowchart for illustrating a portion of process of sending e-mail. In step 31 corresponding to step S4 of FIG. 1, the sender server may analyze an address of the e-mail to be sent in order to obtain an IP address of the recipient. In step 32 corresponding to step S5 of FIG. 1, the sender server attempts to establish a connection with a recipient server based on the obtained IP address of the recipient. Step 33 (i.e., reading a welcome message from the recipient server), step 34 (i.e., sending a “Hello” message to the recipient server), step 35 (i.e., reading a reply from the recipient server), step 36 (i.e., sending a “MAIL FROM” instruction to the recipient server), step 37 (i.e., reading a reply from the recipient server), step 38 (i.e., sending a “RCPT TO” instruction to the recipient server), and step 39 (i.e., reading a reply from the recipient server) correspond to step S6 (i.e., the sender server performs a SMTP procedure to attempt to communicate with the recipient server) of FIG. 1. Step 310 (i.e., sending “DATA” instruction to the recipient server) and step 311 (i.e., reading a reply from the recipient server) correspond to step S7 (i.e., the sender begins to send the e-mail to the recipient server) of FIG. 1. Step 312 (i.e., sending e-mail to the recipient server) and step 313 (i.e., reading a reply from the recipient server) correspond to step S8 (i.e., a reply representing that the recipient has received the e-mail is sent from the recipient to the sender) of FIG. 1. The step is highlighted if an error is occurred therein and a corresponding description is shown. Thus, the sender may take an appropriate action (i.e., sending again) immediately.

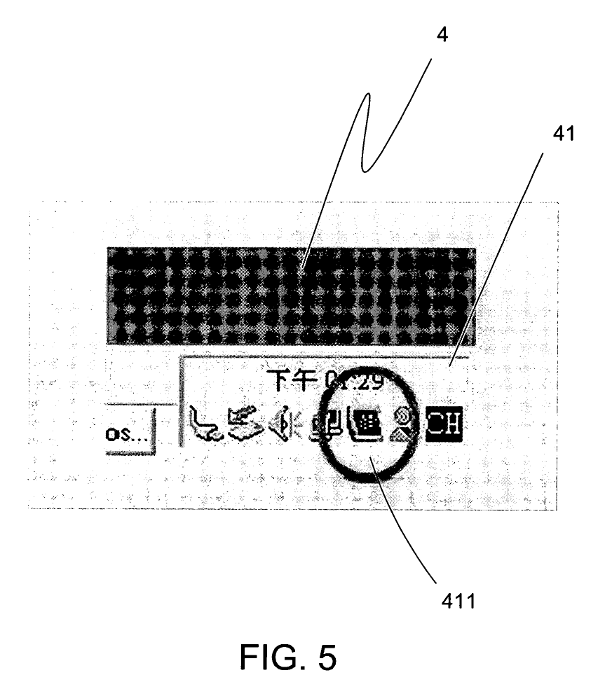

Referring to FIG. 5, an ergonomic interface is shown. For example, an icon 41 in an area 411 on a right bottom corner of the Windows screen 4 is adapted to show a status after sending an e-mail. The icon 41 may indicate the sent e-mail being success or not. Also, the icon 41 is linked to the screen 2 about details of sent e-mails. Thus, clicking the icon 41 may enter the screen 2 about details of sent e-mails automatically.

While the invention herein disclosed has been described by means of specific embodiments, numerous modifications and variations could be made thereto by those skilled in the art without departing from the scope and spirit of the invention set forth in the claims.

What is claimed is:

1. In a sub-system of e-mail sending system a method of inquiring status of a sent e-mail in real time comprising:
displaying a screen of e-mail list having the sent e-mail added therein sequentially wherein the list comprises a plurality of records each representing one of the sent e-mails including serial number, size, subject, sending time, success times, failure times, and times to be sent; a sender is capable of clicking the e-mail in the list to enter a screen about details of sent e-mails; and the screen about details of sent e-mails is shown as a Windows screen or a Web page and includes a success sending portion having a plurality of records each including fields of recipient, date and time of first sending, sending times, time consumed, date and time of the beginning of last sending, date and time of the ending of last sending, and processing time, and a failure sending portion having a plurality of records reach including fields of recipient, date and time of first sending, sending times, time consumed, date and time of the beginning of last sending, date and time of next sending, date and time of the ending of last sending, processing time, and status description for indicating the cause of failure;
linking the status description to enter a description screen including a flowchart for illustrating steps of the e-mail sending wherein the step is highlighted if an error is occurred therein and a corresponding description is shown; and
showing an icon in an area on a computer screen for indicating whether the sent e-mail is a success or not.

2. The method of claim 1, wherein the icon is linked to the screen about details of sent e-mails such that clicking the icon will enter the screen about details of sent e-mails.
